(19) United States
(12) Patent Application Publication
(10) Pub. No.: US 2005/0040368 A1
(43) Pub. Date: Feb. 24, 2005

(54) Temperature sensitive paint for low-temperature use

(75) Inventors: Yoshimi Iijima, Tokyo (JP); Keisuke Asai, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN AEROSPACE EXPLORATION AGENCY, Tokyo (JP)

(21) Appl. No.: 10/745,970

(22) Filed: Dec. 29, 2003

(30) Foreign Application Priority Data
Aug. 22, 2003 (JP) 2003-299327

(51) Int. Cl. G01N 31/22

(52) U.S. Cl. 252/408.1; 106/31.14

(57) ABSTRACT

The present invention provides a temperature sensitive paint for low-temperature use which shows durability at low temperatures, has a high light emission intensity, and makes it possible to perform precise temperature measurements of surface temperature fields by applying the paint to the surface of an object and measuring the light emission even in cases where the measurement distance is long in, for example, a large cryogenic wind tunnel or the like. The temperature sensitive paint for low-temperature use contains a ruthenium complex having a high light emission intensity as a temperature sensitive luminophore, a urethane type polymer as a binder, and an alcohol organic solvent as a solvent. Use of an alcohol organic solvent makes it possible to dissolve a temperature sensitive luminophore at a high solubility and to increase the light emission intensity by raising the temperature sensitive luminophore concentration in the coating film, so that more precise temperature measurements can be performed. By using the urethane type polymer having the durability at low-temperature, it is possible to obtain durability where no cracks occur at low temperatures even when the film thickness is increased. Therefore, adjustment of the light emission intensity and surface treatment such as surface polishing and the like can be performed by using this temperature sensitive paint for low-temperature use.

### BACKGROUND OF THE INVENTION

1. Field of the Invention

The present invention relates to a temperature sensitive paint for low-temperature use which is used to measure the surface temperatures of objects or surface temperature fields such as the distribution of such surface temperatures in cases where the temperatures of such objects or of fluids surrounding such objects are low temperatures.

2. Description of the Related Art

Methods in which the surface temperatures of objects are measured by coating the surfaces of the objects with a temperature sensitive paint, and then detecting the intensity of light emitted by the temperature sensitive paint, have been known in the past as methods for measuring the surface temperatures of objects. Temperature sensitive paints are ordinarily constructed from the temperature sensitive luminophore whose light emission intensity varies according to temperature, and a binder by which such a temperature sensitive luminophore is supported in the paint. Generally, methods in which the amount (concentration) of temperature sensitive luminophore contained in the temperature sensitive paint is increased, or methods in which the thickness of the paint coating film is increased, are used in order to increase the light emission intensity of temperature sensitive paints. However, since such luminophores may be almost insoluble depending on the type of binder used, there are limits to how far the light emission intensity can be increased. Furthermore, examples of binders used in temperature sensitive paints in the past include dimethylsiloxane type polymers; however, as is indicated by the durability at low-temperature data shown in Table 1, such polymers suffer from the problem of the generation of micro-cracks at low temperatures when the film thickness is thick.

TABLE 1
Durability at low-temperature of
dimethylsiloxane type polymers

| | Presence or absence of |
|---|---|
| Coating film | cracks at a |
| thickness (μm) | temperature of 77 K |
| 4.8 | No |
| 6.0 | No |
| 7.6 | micro-cracks appeared |
| 17.6 | micro-cracks appeared |
| 20.0 | micro-cracks appeared |

As a countermeasure against such generation of fine cracks at low temperatures, it is necessary to coat the surface of the object with the temperature sensitive paint while limiting the film thickness. However, such a painting operation is generally difficult. Furthermore, in the case of a limited film thickness, a sufficient amount of luminophore cannot be included [in the coating film]; accordingly, the light emission intensity required for measurement cannot be obtained. Furthermore, in cases where experiments are performed in large size cryogenic wind tunnels in which wind tunnel models whose surfaces are coated with a temperature sensitive paint are placed in the test section of the wind tunnel, and surface temperature fields on the wind tunnel models are measured, the measurement distance between the model and the measuring instrument is increased as a result of an increase in the size of the test section in which the model is disposed; consequently, the following problem arises: namely, a bright temperature sensitive paint with a large light emission intensity is required in order to increase the amount of light that is incident on the measuring instrument. Accordingly, it is difficult to use conventional temperature sensitive paints in cryogenic wind tunnels.

It has been proposed that ruthenium complexes be used as temperature sensitive luminophores contained in temperature sensitive paints. The evaluation of three temperature sensitive paint luminophores, i.e., tris(2,2′-bipyridyl)ruthenium (II), di(tripyridyl)ruthenium (II) and ruthenium (VH127) in the absolute temperature range of 100 to 298 Kelvin using a cryostat cooled by liquid nitrogen and a spectrofluorometer has been reported in the visualization of boundary layer transitions in a cryogenic wind tunnel by means of temperature sensitive paints (see Yoshimi Iijima and two others, “Visualization of Boundary Layer Transitions in a Cryogenic Wind Tunnel by Means of Temperature Sensitive Paints”, Collection of Papers Presented at the 29^{th} Symposium on Visualization, July 2001, Vol. 21, No. 1, pp. 329-331). Among these materials, a temperature sensitive paint using di(tripyridyl)ruthenium (II) as a sensor probe and GP197 as a binder showed the highest sensitivity. Furthermore, a paint using an epoxy as a binder was used as a heat insulating material for the test samples. It is disclosed here that no cracks are observed even at low temperatures as long as the overall thickness is less than 80 μm (10 μm of GP197 and 70 μm of the underlayer (epoxy)). Furthermore, GP197 is a dimethylsiloxane type polymer provided by Genesee Polymers Corporation. (USA); the solvent has the components shown in Table 2 (citation: MSDS (MATERIAL SAFETY DATA SHEET)).

TABLE 2
Table of components
solvent of GP197 (cited from MSDS)

| Component | wt % |
|---|---|
| Methanol | <5 |
| Ethanol | <5 |
| 1,1,1-Trichloroethane | 70 |
| Isopropyl alcohol (propanol) | 10 |
| Butyl alcohol | <5 |

Furthermore, optimization of a method for preparing di(tripyridyl)ruthenium(II)/GP197 has been reported (see Yoshimi Iijima and two others, “Optimization of Temperature Sensitive Paint Used in Cryogenic Wind Tunnels”, Collection of Papers Presented at the 30^{th} Symposium on Visualization, July 2002, Vol. 22, No. 1, pp. 321-324). According to this report, the fluorescent light emission intensity of the paint shows a maximum value at a luminophore concentration of 1.2 to 1.4 mg/ml. It has been reported that micro-cracks are generated at ultra-low temperatures in the case of a temperature sensitive paint coating film with a thickness exceeding approximately 6 μm. Thus, since the film thickness is limited, the application of a uniform film is difficult. Meanwhile, it is known that the roughness of the model surface affects conspicuously the measurement of a cryogenic wind tunnel; so that the RMS surface roughness can be reduced to a value of 0.15 μm by a surface polishing process. This process is also difficult in cases where the film thickness is restricted.

Accordingly, in temperature sensitive paints for use at low temperatures, there is a need to obtain a combination of temperature sensitive luminophore, binder and solvent which shows durability at low-temperature in terms of preventing the generation of cracks or the like in a low-temperature environment even in the case of a large film thickness, which makes it possible to dissolve the temperature sensitive luminophore at a high solubility, and which makes it possible to increase the light emission intensity by including the temperature sensitive luminophore in the film in large amounts and at a high concentration when this combination is applied to the surface of an object by coating or the like.

### SUMMARY OF THE INVENTION

It is an object of the present invention to provide a temperature sensitive paint for low-temperature use which shows durability such as the prevention of cracks in the film at low temperatures even when the paint is applied to a thick film thickness in the low-temperature range of (for example) 0° C. or lower, which consequently allows light emission intensity adjustment such as increasing the light emission intensity by increasing the amount of temperature sensitive luminophore in the film when the paint is applied to the surface of an object by coating or the like, and surface treatment such as polishing of the film surface or the like, and which makes it possible to perform precise temperature measurements even in cases where the measurement distance is long in, for example, a large cryogenic wind tunnel or the like.

In order to achieve the abovementioned object, the temperature sensitive paint for low-temperature use provided by the present invention contains a ruthenium complex as a temperature sensitive luminophore, a urethane type polymer as a binder, and an alcohol organic solvent as a solvent.

In this temperature sensitive paint for low-temperature use, since a ruthenium complex is used as the temperature sensitive luminophore, the high light emission intensity that is inherent in ruthenium complexes is manifested so that high-precision temperature measurements can be performed. Furthermore, since a urethane type polymer is used as the binder, the durability at low-temperature that is inherent in urethane type polymers is exhibited in the temperature sensitive paint as well. Moreover, it was discovered that the use of an alcohol organic solvent makes it possible to dissolve ruthenium complexes constituting temperature sensitive luminophores at a high solubility. Accordingly, a temperature sensitive paint for low-temperature use in which a temperature sensitive luminophore is dissolved at a high concentration can be applied to the surfaces of objects as a thick film by means such as coating or the like, so that emitted light with a large variation in light emission intensity in response to the temperature change can be measured from a temperature sensitive paint containing large amounts of the temperature sensitive luminophore even in low-temperature environments, or even if the measurement distance is long.

The abovementioned temperature sensitive luminophore that is used in this temperature sensitive paint for low-temperature use may be a ruthenium complex selected from the group consisting of di(tripyridyl)ruthenium (II), tris(2,2′-bipyridyl)ruthenium (II), ruthenium(VH127) [Ru(VH127)], ruthenium bis(2,2′-bipyridine)(2,2′:6′2″1-terpyridine) and ruthenium bis(4,4′,5,5′-tetramethyl-2,2′-bipyridine)(2,2′:6′2″-terpyridine). Below, di(tripyridyl)ruthenium (II) will be abbreviated to “Ru(trpy)₂²⁺”,), tris(2,2′-bipyridyl)ruthenium (II) will be abbreviated to “Ru(bpy)₃²⁺”, ruthenium(VH127) will be abbreviated to “Ru(VH127)²⁺”, ruthenium bis(2,2′-bipyridine)(2,2′:6′2″-terpyridine) will be abbreviated to “Ru(bpy)₂(trpy)²⁺”, and ruthenium bis(4,4′,5,5′-tetramethyl-2,2′-bipyridine)(2,2′:6′2″-terpyridine) will be abbreviated to “Ru(Mebpy)₂(trpy)²⁺”.

Furthermore, in this temperature sensitive paint for low-temperature use, primary saturated monohydric alcohols may b used as alcohol organic solvents. Examples of such primary saturated monohydric alcohols include ethanol, methanol, propanol and isobutanol.

As was described above, the temperature sensitive paint for low-temperature use provided by the present invention uses a ruthenium complex as a temperature sensitive luminophore; accordingly, the high light emission intensity that is inherent in ruthenium complexes is manifested so that high-precision temperature measurements can be performed. Furthermore, since a urethane type polymer is used as a binder, the durability at low-temperature of urethane type polymers is also manifested in the temperature sensitive paint. Moreover, since an alcohol organic solvent is used as a solvent, the temperature sensitive luminophore can be dissolved at a high solubility. Accordingly, a temperature sensitive paint for low-temperature use in which a temperature sensitive luminophore is dissolved at a high concentration can be applied to the surfaces of objects as a thick film by means such as coating or the like, so that emitted light with a large variation in light emission intensity can be measured from a temperature sensitive paint containing large amounts of the temperature sensitive luminophore even in low-temperature environments, or even if the measurement distance is long.

The temperature sensitive paint for low-temperature use provided by the present invention achieves the following improvement in durability at low-temperature: namely, even if the coating film thickness is increased, cracking does not occur at low temperatures. Accordingly, there is no need for coating control in ultra-thin films, and the limiting value on the film thickness can be greatly relaxed, so that the application of coatings to the surfaces of objects is correspondingly facilitated. Furthermore, since the film thickness can be increased, the total amount of the temperature sensitive luminophore contained in the temperature sensitive paint film can be adjusted, so that (for example) light emission intensity adjustments such as an increase in the quantity of light emitted, a further increase in the intensity of light emission per unit area and the like can made. Furthermore, if the film thickness is large, a sufficient film thickness can be insured even if the surface is polished. Accordingly, surface treatment including finishing to an extremely smooth surface roughness, to the extent that boundary layer transitions caused by the effects of surface roughness do not occur, is possible in the case of tests performed in wind tunnels with high Reynolds number. Thus, the temperature sensitive paint of the present invention is a useful temperature sensitive paint for low-temperature use which can be employed in tests performed in large cryogenic wind tunnels.

### BRIEF DESCRIPTION OF THE DRAWINGS

FIG. 1 is a diagram which shows an example of the structural formulae of ruthenium complexes used in the temperature sensitive paint for low-temperature use provided by the present invention;

FIG. 2 is a graph which shows the temperature dependence of the light emission of the luminophore in a case where Ru(trpy)₂²⁺ was used as a temperature sensitive luminophore in the temperature sensitive paint for low-temperature use provided by the present invention; and

FIG. 3 is a photograph showing a typical example of visualization of boundary layer transitions performed in a transonic cryogenic wind tunnel for a wing whose wing surfaces were coated with the temperature sensitive paint for low-temperature use provided by the present invention.

### DESCRIPTION OF THE PREFERRED EMBODIMENTS

Embodiments of the temperature sensitive paint for low-temperature use provided by the present invention will be described below with reference to the attached figures.

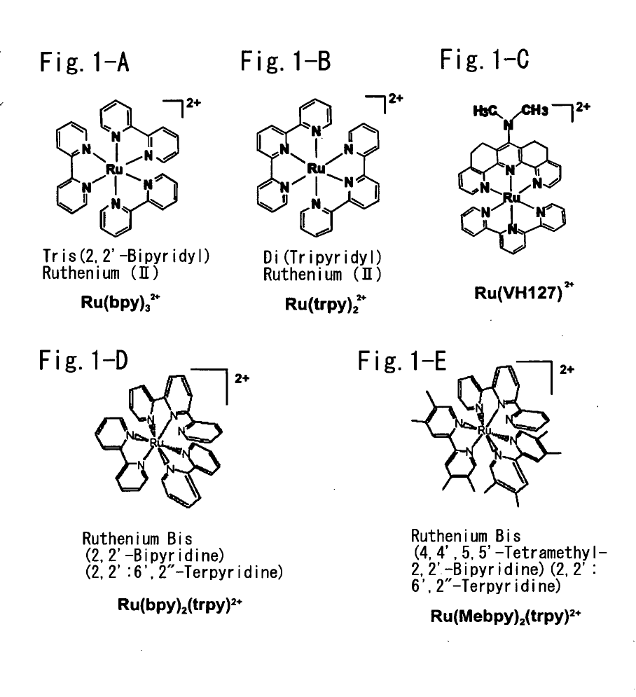

An example of the structural formulae of the ruthenium complexes used in the temperature sensitive paint for low-temperature use provided by the present invention are shown in FIG. 1. FIG. 1(a) shows the structural formula of Ru(bpy)₃²⁺, FIG. 1(b) shows the structural formula of Ru(trpy)₂²⁺, FIG. 1 (c) shows the structural formula of Ru(VH127)²⁺, FIG. 1(d) shows the structural formula of Ru(bpy)₂(trpy)²⁺, and FIG. 1 (e) shows the structural formula of Ru(Mebpy)₂(trpy)²⁺. The compounds indicated by the respective structural formulae are metal complexes which have a ruthenium ion at the center, and organic compounds surrounding this ion as ligands.

The temperature sensitive paint for low-temperature use provided by the present invention is constructed using ruthenium complexes having the structural formulae shown above as a temperature sensitive luminophore, using a urethane type polymer as a binder, and using an alcohol as a solvent. The luminophore solubility of the temperature sensitive luminophore [Ru(trpy)₂]Cl₂ was measured for various types of solvents in the category of methanol or lower. It was ascertained that this temperature sensitive luminophore had a superior solubility in pure alcohol solvents. The abovementioned GP197 is a binder which contains a dimethylsiloxane type polymer and a solvent (see Table 2); the abovementioned temperature sensitive luminophore can be dissolved in this binder to a concentration of 0.2 mg/ml. Furthermore, the urethane type clear paint thinner C25/90S manufactured by Akzo Nobel Co. can dissolve the above-mentioned temperature sensitive luminophore to a concentration of 0.2 mg/ml. Furthermore, it was found that if methanol as an alcohol organic solvent is mixed with the above-mentioned thinner C25/90S at a volume ratio of 1:1, this mixed solvent can dissolve the abovementioned temperature sensitive luminophore to a concentration of 4 mg/ml or greater.

The measurement results obtained for the solubility of Ru(trpy)₂²⁺ by solvents are shown in Table 3. In the case of Ru(trpy)₂²⁺, [Ru(trpy)₂]Cl₂ with a chloride counter ion was used, and the test temperature was set at room temperature (26° C.). In the case of solvents other than alcohol organic solvents, the solubility was extremely poor; for example, it was found that the temperature sensitive luminophore cannot be dissolved by toluene. The respective components of a lacquer thinner solution provided by Kanpe Hapio Co. and AK-15 and JAB-05N provided by DuPont Co. are shown in Table 4. Furthermore, it appears that the reason for the good solubility results shown by the abovementioned thinner C25/90S manufactured by Akzo Nobel Co. is that this thinner contains propanol as a thinner component, as is indicated in Table 4 (citation: MSDS). In cases where methanol, ethanol, propanol or isobutanol was used as an alcohol organic solvent, good solubility results showing extremely good dissolution of the temperature sensitive luminophore Ru(trpy)₂²⁺ were obtained.

TABLE 3
Solubility of [Ru(trpy)₂]Cl₂
[Luminophore concentration 0.5 mg/ml, room temperature 26° C.]
(* indicates product name)

| Solvent | Class | Solubility |
|---|---|---|
| Methanol | Alcohol | ⊚ |
| Isobutanol | Alcohol | ⊚ |
| Ethanol | Alcohol | ⊚ |
| Propanol | Alcohol | ⊚ |
| C25/90S(manufactured by Akzo Nobel Co.)* | Thinner | ◯ |
| Lacquer thinner solution | Thinner | X |
| (manufactured by Kanpe Hapio Co.)* | | |
| AK-15 (manufactured by DuPont Co.)* | Thinner | X |
| JAB-05N (manufactured by DuPont Co.)* | Thinner | X |
| Ethyl acetate | Esters | X |
| Butyl acetate | Esters | X |
| Acetone | Ketones | X |
| Methyl ethyl ketone | Ketones | X |
| Methyl isobutyl ketone | | X |
| Dichloromethane | Halogenated | ◯ |
| | compound | |
| Toluene | Aromatic | X |
| | hydrocarbon | |
| Xylene | Aromatic | X |
| | hydrocarbon | |
| Ethylbenzene | | X |

⊚ Extremely good solutility
◯ [some] solubility
Δ Almost no solubility
X No solubility

TABLE 4
Table of components of various types of thinners
(the thinners are all shown as product names from MSDS)

| | |
|---|---|
| Lacquer thinner solution | Xylene |
| (manufactured by | Butyl acetate |
| Kanpe Hapio Co.) | Ethylbenzene |
| | Ethylene glycol monobutyl ether |
| | Isobutanol |
| C25/90S | Propanol |
| (manufactured by | Methyl ethyl ketone |
| Akzo Nobel Co.) | Methyl isobutyl ketone |
| | 2-Methoxy-1-methylethyl acetate |
| AK-15 | Toluene |
| (manufactured by | Xylene |
| DuPont Co.) | Ethyl acetate |
| | Butyl acetate |
| JAB-05N | Toluene |
| (manufactured by | Xylene |
| DuPont Co.) | Butyl acetate |
| | Acetone |

The durability at low-temperature characteristics of urethane type polymers are shown in Tables 5 and 6. As is shown in Table 5, it was confirmed that a polymer in which a hexane 1,6-diisocyanate homopolymer and hexamethylene 1,6-diisocyanate are used as the raw materials of the polyurethane shows no cracking at an absolute temperature of 77K, even at a coating film thickness of 125 μm.

TABLE 5
Durability at low-temperature
of urethane type polymer

| | Presence or absence of |
|---|---|
| Coating film | cracking at a |
| thickness (μm) | temperature of 77 K |
| 20.9 | No |
| 43.6 | No |
| 59.5 | No |
| 80.0 | No |
| 125.0 | No |

Furthermore, as is shown in Table 6, it was confirmed that a polymer in which an aliphatic polyisocyanate and a hexamethylene diisocyanate polymer (HDI polymer) are used as the raw materials of the polyurethane shows no cracking at an absolute temperature of 77K, to a coating film thickness of 40 μm.

TABLE 6
Durability at low-temperature
of urethane type polymer

| | Presence or absence of |
|---|---|
| Coating film | cracking at a |
| thickness (μm) | temperature of 77 K |
| 16.8 | No |
| 23.4 | No |
| 40.9 | No |
| 49.6 | Cracks appeared |
| 62.5 | Cracks appeared |

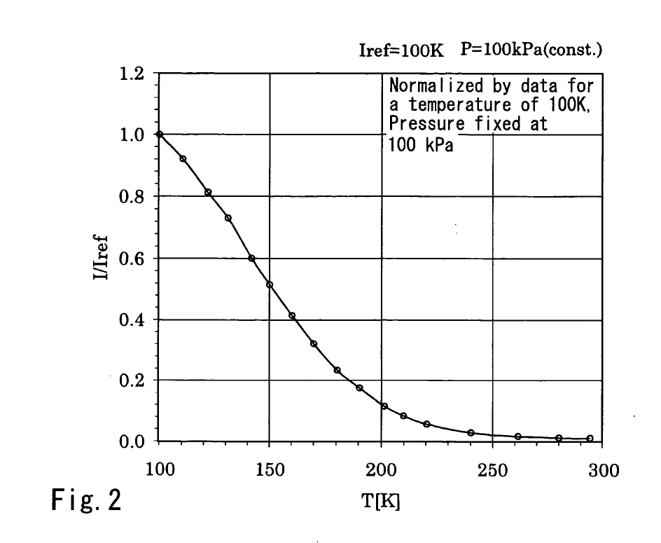

FIG. 2 shows the temperature dependence of the temperature sensitive luminophore in a case where Ru(trpy)₂²⁺ was used as the temperature sensitive luminophore. In FIG. 2, the horizontal axis shows the absolute temperature, and the vertical axis shows the ratio of the light emission intensity to a reference light emission intensity. It is seen that this luminophore has a substantially linear sensitivity at absolute temperatures from 200K to 100K. Furthermore, when the reference light emission intensity of a dimethylsiloxane type polymer (film thickness 6 μm) and the reference light emission intensity of a urethane type polymer (film thickness 20 μm) are compared, it is seen that the light emission intensity of the urethane type polymer is greater than that of the dimethylsiloxane type polymer by an amount corresponding to the increase in thickness; in the present example, this increase is the light emission intensity reaches a value of approximately 2.8 times.

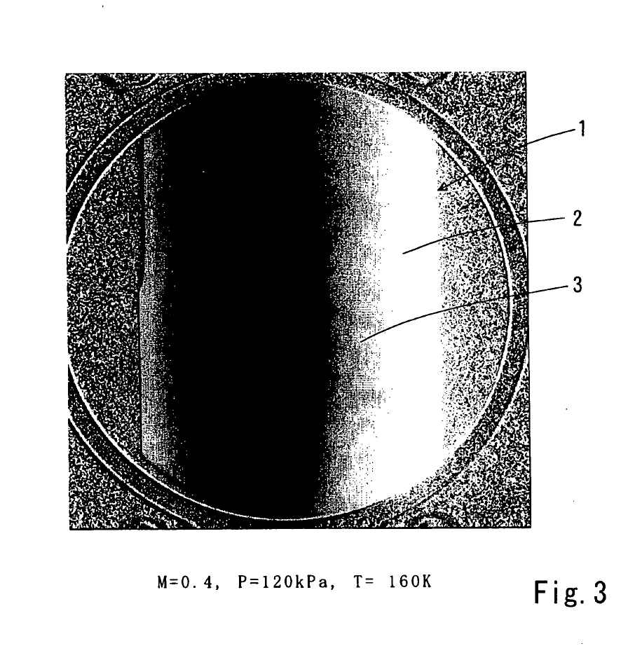

A verification test of the temperature sensitive paint for low-temperature use provided by the present invention was performed by means of a wind tunnel test performed using a transonic cryogenic wind tunnel. A wing whose wing surfaces were coated with the temperature sensitive paint for low-temperature use provided by the present invention was placed in the test section of the transonic cryogenic wind tunnel, and the temperature distribution accompanying boundary layer transitions on the wing surfaces was measured in a wind tunnel test performed in the transonic cryogenic wind tunnel. A typical example of visualization of the temperature distribution obtained in this case is shown as a photograph in FIG. 3. In FIG. 3, the bright-dark boundary 3 on the wing surface 2 located in a position that is approximately 60% in the direction of the wing chord of the wing 1 indicates a position where the temperature abruptly changes; the boundary 3 corresponds to the position of a natural transition of the boundary layer.

As a result of the use of a ruthenium complex as a temperature sensitive luminophore in this embodiment of the temperature sensitive paint for low-temperature use, the property of a high light emission intensity that is inherent in ruthenium complexes is manifested; furthermore, the solubility is improved by the use of an alcohol solvent to dissolve the temperature sensitive luminophore so that the temperature sensitive paint with high light emission in intensity can be obtained. Moreover, as a result of the use of a urethane type polymer as a binder, the property of showing durability at low-temperature even at a thick film thickness that is inherent in urethane type polymers is also manifested, so that a temperature sensitive paint for low-temperature use that has a large light emission intensity is obtained as shown in FIG. 2, and so that there is room in the film thickness for adjustment of the light emission intensity and surface control such as surface polishing and the like in accordance with the test conditions and the like.

1. A temperature sensitive paint for low-temperature use which contains a ruthenium complex as a temperature sensitive luminophore, a urethane type polymer as a binder, and an alcohol organic solvent as a solvent.

2. The temperature sensitive paint for low-temperature use according to claim 1, wherein said temperature sensitive luminophore is a ruthenium complex selected from the group consisting of di(tripyridyl)ruthenium (II), tris(2,2′-bipyridyl)ruthenium (II), ruthenium(VH127), ruthenium bis(2,2′-bipyridine)(2,2′:6′2″-terpyridine) and ruthenium bis(4,4′,5,5′-tetramethyl-2,2′-bipyridine)(2,2′:6′2″-terpyridine).

3. The temperature sensitive paint for low-temperature use according to claim 1, wherein said alcohol organic solvent is a primary saturated monohydric alcohol.
